(19) United States
(12) Patent Application Publication
(10) Pub. No.: US 2007/0079555 A1
(43) Pub. Date: Apr. 12, 2007

(54) Safety gate including a pair of restoring mechanisms that act in opposite directions

(76) Inventor: Red Lan, Taipei Hsien (TW)

Correspondence Address: HARNESS, DICKEY & PIERCE, P.L.C., P.O. BOX 8910, RESTON, VA, 20195, US

(21) Appl. No.: 11/246,230

(22) Filed: Oct. 11, 2005

(51) Int. Cl. E06B 9/01

(52) U.S. Cl. 49/57; 49/386

(57) ABSTRACT

A safety gate includes a gate frame, a gate member, and first and second restoring mechanisms for mounting pivotally the gate member on the gate frame such that the gate member can be swung in a first direction from a closed position to a first open position, and in a second direction from the closed position to a second open position. The first restoring mechanism operates to accumulate a restoring force for restoring the gate member from the first open position to the closed position when the gate member is swung in the first direction from the closed position to the first open position. The second restoring mechanism operates to accumulate a restoring force for restoring the gate member from the second open position to the closed position when the gate member is swung in the second direction from the closed position to the second open position.

### BACKGROUND OF THE INVENTION

1. Field of the Invention

The invention relates to a safety gate, more particularly to a safety gate including a pair of restoring mechanisms that act in opposite directions.

2. Description of the Related Art

A safety gate is mounted across two opposite surfaces, such as posts, walls, etc., for confining a child or a pet in a space. A conventional safety gate includes a gate member that can be opened in two opposite directions for added convenience during use. The conventional safety gate further includes a single spring for restoring the gate member to a closed position. However, regardless of whether the spring in the conventional safety gate is a compression spring or an extension spring, the spring can effectively accumulate a restoring force in only one opening direction. By forcing the spring to act ineffectively in the opposite opening directions, the spring is easily damaged, thereby disabling the restoring functionality of the safety gate after a period of use.

### SUMMARY OF THE INVENTION

Therefore, the object of the present invention is to provide a safety gate including a pair of restoring mechanisms that act in opposite directions so as to overcome the aforesaid drawback associated with the prior art.

Accordingly, the safety gate of the present invention comprises a gate frame, a gate member, and first and second restoring mechanisms for mounting pivotally the gate member on the gate frame such that the gate member can be swung relative to the gate frame about a pivot axis in a first direction from a closed position to a first open position, and in a second direction from the closed position to a second open position. The first restoring mechanism operates to accumulate a restoring force for restoring the gate member from the first open position to the closed position when the gate member is swung in the first direction from the closed position to the first open position. The second restoring mechanism operates to accumulate a restoring force for restoring the gate member from the second open position to the closed position when the gate member is swung in the second direction from the closed position to the second open position.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a safety gate according to the present invention;

FIG. 2 is a top view to illustrate first and second open positions of a gate member of the preferred embodiment;

FIG. 3 is a fragmentary exploded perspective view to illustrate first and second restoring mechanisms of the preferred embodiment;

FIG. 4 is a fragmentary sectional view of the preferred embodiment to illustrate an assembled state of the first and second restoring mechanisms;

FIG. 5 is an exploded perspective view to illustrate components of the first restoring mechanism;

FIG. 6 is a sectional view of the first restoring mechanism, taken along line 6-6 in FIG. 4; and

FIG. 7 is a sectional view of the second restoring mechanism, taken along line 7-7 in FIG. 4.

### DETAILED DESCRIPTION OF THE PREFERRED EMBODIMENT

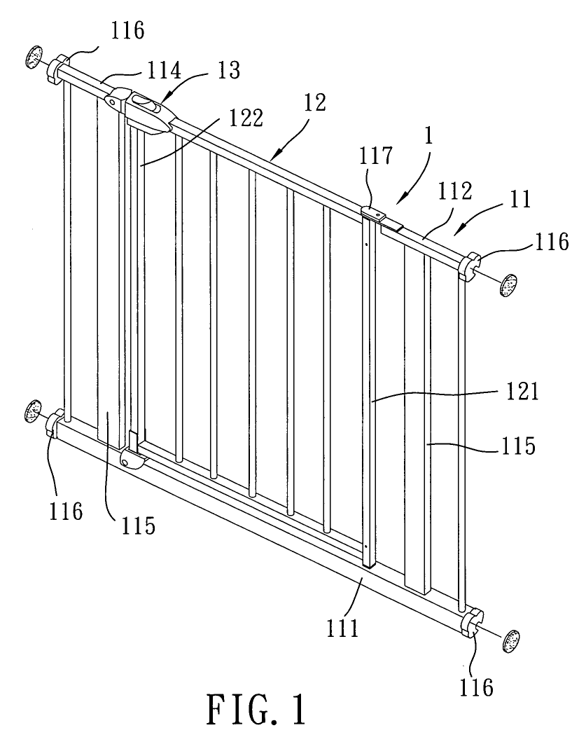

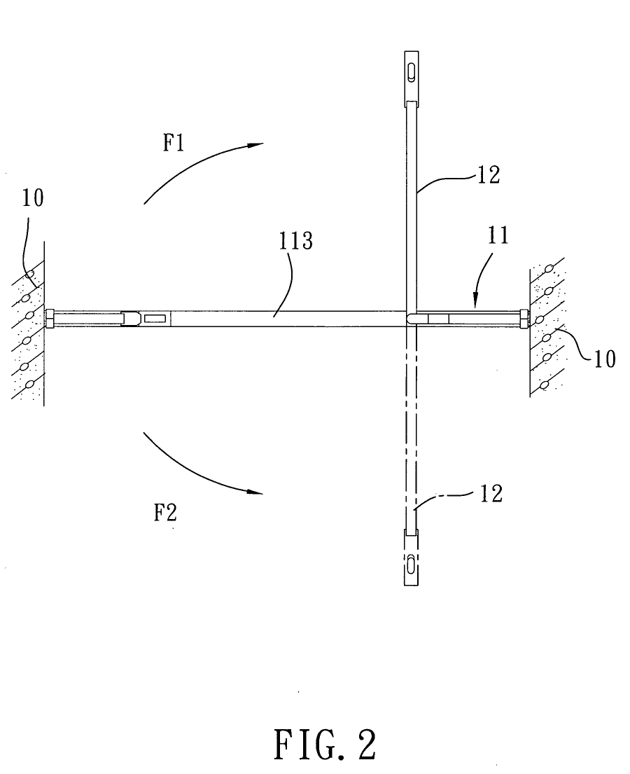

Referring to FIGS. 1, 2 and 3, the preferred embodiment of a safety gate 1 according to the present invention is shown to be adapted to be mounted upright across two opposite surfaces 10, such as posts, walls, etc. The safety gate 1 comprises a gate frame 11, a gate member 12, and first and second restoring mechanisms 14, 14′ for mounting pivotally the gate member 12 on the gate frame 11 such that the gate member 12 can be swung relative to the gate frame 11 about a pivot axis (A) in a first direction (F1) from a closed position (see FIG. 1) to a first open position (shown in solid lines in FIG. 2), and in a second direction (F2) from the closed position to a second open position (shown in phantom lines in FIG. 2).

The gate frame 11 of this embodiment includes a horizontal bottom frame part 111, first and second top frame parts 112, 114 disposed above the bottom frame part 111, shorter than the bottom frame part 111, and horizontally spaced apart from each other to define a gate opening 113 therebetween, a set of connecting posts 115 that connect the first and second top frame parts 112, 114 to the bottom frame part 111, and four wall clamps 116 mounted respectively on the first and second top frame parts 112, 114 and on two lateral ends of the 15 bottom frame part 111. The wall clamps 116 are conventional in construction, and are operable to hold the gate frame 11 across the two opposite surfaces 10 in a manner well known in the art. The bottom frame part 111 has a gate connecting section formed with an insert hole 110. The first top frame part 112 also has a gate connecting section 117 formed with an insert hole 110′. Each of the insert holes 110, 110′, which are aligned along the pivot axis (A), includes a circular part 118 and a positioning part 119 that extends radially from the circular part 118. The positioning parts 119 of the insert holes 110, 110′ form an angle of about 90 degrees therebetween.

The gate member 12 has a pivot end 121 pivoted to the gate frame 11, and a latching end 122 opposite to the pivot end 121. The safety gate 1 further comprises a conventional latch 13 for latching releasably the latching end 122 of the gate member 12 to the gate frame 11 at the closed position in a manner well known in the art. In this embodiment, the gate member 12 includes a tubular post 123 at the pivot end 121. The tubular post 123 extends between the insert holes 110, 110′, and includes a rectangular tube wall 125 that confines a post space 124. The post space 124 has opposite open ends 126. The tube wall 125 is formed with a pair of radial retainer holes 127, each of which is disposed adjacent to a respective one of the open ends 126.

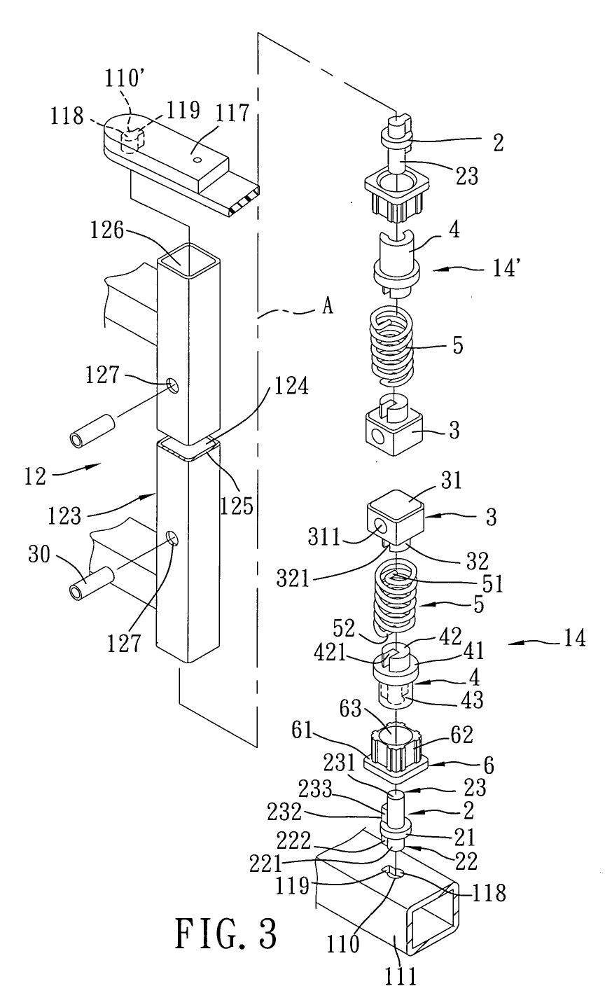

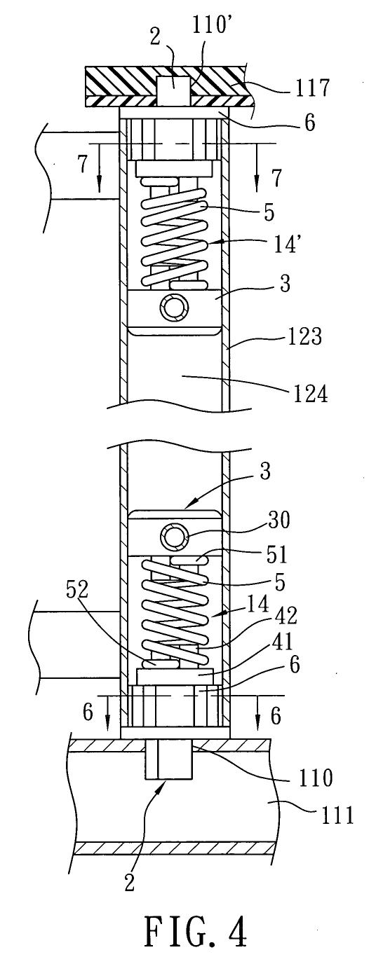

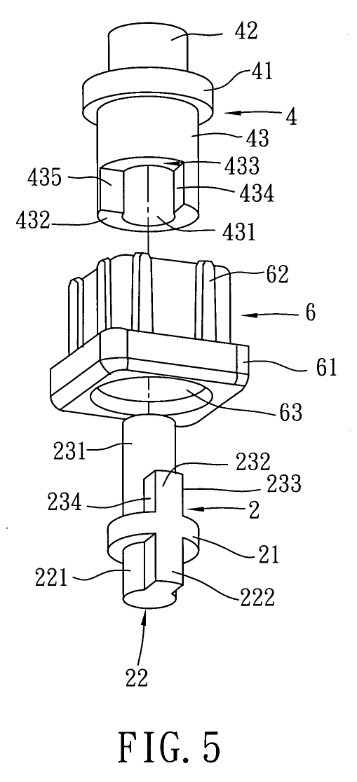

With further reference to FIGS. 3, 4 and 5, the first and second restoring mechanisms 14, 14′ are shown to be identical in structure and to differ primarily in the assembly directions thereof. The first restoring mechanism 14 operates to accumulate a restoring force for restoring the gate member 12 from the first open position to the closed position when the gate member 12 is swung in the first direction (F1) from the closed position to the first open position. The second restoring mechanism 14′ operates to accumulate a restoring force for restoring the gate member 12 from the second open position to the closed position when the gate member 12 is swung in the second direction (F2) from the closed position to the second open position. Each of the first and second restoring mechanisms 14, 14′ is disposed in the tubular post 123 of the gate member 12, and includes an anchor seat 3, a restoring spring 5, a control seat 4, and an actuator 2.

The anchor seat 3 includes a base part 31 that is formed with a retainer hole 311, and a spring mounting part 32 that extends from the base part 31 and that is formed with a spring engaging groove 321. The base part 31 has dimensions corresponding to those of the post space 124, and is fixed in the post space 124 by a retainer 30 that extends through one of the retainer holes 127 in the tubular post 123 and the retainer hole 311 in the base part 31.

The restoring spring 5 is a helical spring in this embodiment, and has first and second spring ends 51, 52. The first spring end 51 engages the spring engaging groove 321 in the spring mounting part 32 of the anchor seat 3, thereby anchoring the first spring end 51 to the gate member 12.

In this embodiment, the control seat 4 includes a circular base wall 41, a spring mounting stud 42 that extends from one side of the base wall 41 and that is formed with a spring engaging groove 421, and a control tube 43 having a tubular wall 432 that extends from the other side of the base wall 41 and that surrounds the pivot axis (A). The second spring end 52 of the restoring spring 5 engages the spring engaging groove 421 in the spring mounting stud 42 of the control seat 4, thereby coupling the control seat 4 to the second spring end 52. The tubular wall 432 of the control tube 43 confines a tube space 431, and is formed with a circumferentially extending control slot 433 having opposite slot ends 434, 435.

The actuator 2 is connected to the gate frame 11 at a respective one of the insert holes 110, 110′. In this embodiment, the actuator 2 includes a base part 21, an insert part 22 that extends from one side of the base part 21 and that is inserted non-rotatably into the respective one of the insert holes 110, 110′, and a rotation control part 23 that extends from the other side of the base part 21 and into the tube space 431 of the control tube 43 of the control seat 4. The insert part 22 has circular and radial sections 221, 222 that correspond to the circular and radial parts 118, 119 of the respective insert hole 110, 110′. The rotation control part 23 includes a post section 231 and a stop 232 that is formed on the post section 231, that is disposed radially relative to the pivot axis (A), and that extends into the control slot 433 in the control seat 4. The stop 232 has a circumferential width shorter than a circumferential length of the control slot 433, and opposite lateral sides 233, 234.

Preferably, each of the first and second restoring mechanisms 14, 14′ further includes an end cap 6 mounted at a respective one of the open ends 126 of the post space 124. The end cap 6 includes a flange 61 seated on a respective distal edge of the tubular post 123, and a sleeve part 62 connected to the flange 61 and fitted in the respective open end 126. The end cap 6 confines a space 63 that is formed through the flange 61 and the sleeve part 62 for extension of the base part 21 and the rotation control part 23 of the actuator 2 therein.

To mount the first and second restoring mechanisms 14, 14′ on the gate member 12, the anchor seats 3, the restoring springs 5, the control seats 4 and the end caps 6 are assembled in sequence in the tubular post 123. Thereafter, the actuators 2 are connected to the insert holes 110, 110′, and are subsequently extended into the end caps 6. Assembly is completed when the gate connecting section 117 is secured to the first top frame part 112.

Referring to FIGS. 1, 3, 6 and 7, after assembly, when the gate member 12 is disposed at the closed position, while the lateral sides 233 of the stops 232 of the actuators 2 of the restoring mechanisms 14, 14′ abut against one end 434 of the control slot 433 in the respective control seat 4, the stops 232 form an angle of about 90 degrees therebetween, and the two restoring springs 5 are mounted in opposite directions. Hence, the first and second restoring mechanisms 14, 14′ operate to accumulate restoring forces in opposite directions.

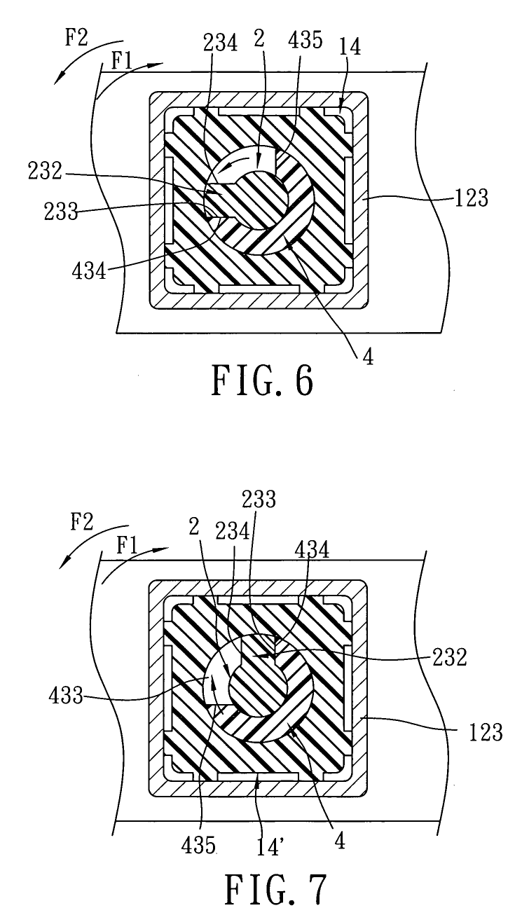

In particular, when the gate member 12 is swung in the first direction (F1) from the closed position to the first open position, the anchor seats 3 of the first and second restoring mechanisms 14, 14′ rotate with the tubular post 123 of the gate member 12 about the pivot axis (A) in the first direction (FI). As shown in FIG. 6, when the anchor seat 3 of the first restoring mechanism 14 rotates in the first direction (F1) such that the first spring end 51 of the restoring spring 5 rotates therewith, because the stop 232 on the actuator 2 abuts against the end 434 of the control slot 433 in the control seat 4, the actuator 2 arrests rotation of the control seat 4 relative to the gate frame 11 about the pivot axis (A), and the first spring end 51 rotates relative to the second spring end 52 of the restoring spring 5, thereby enabling the restoring spring 5 of the first restoring mechanism 14 to accumulate the restoring force for restoring the gate member 12 from the first open position back to the closed position. In the meantime, as shown in FIG. 7, when the anchor seat 3 of the second restoring mechanism 14′ rotates in the first direction (F1) such that the first spring end 51 of the restoring spring 5 rotates therewith, due to the angular displacement between the stops 232 of the first and second restoring mechanisms 14, 14′, the actuator 2 of the second restoring mechanism 14′ permits rotation of the control seat 4 of the second restoring mechanism 14′ with the tubular post 123 of the gate member 12 in the first direction (F1) such that relative rotation between the first and second spring ends 51, 52 of the restoring spring 5 of the second restoring mechanism 14′ can be avoided. In other words, the second restoring mechanism 14′ does not accumulate a restoring force when the gate member 12 is swung from the closed position to the first open position.

On the other hand, when the gate member 12 is swung in the second direction (F2) from the closed position to the second open position, the anchor seats 3 of the first and second restoring mechanisms 14, 14′ rotate with the tubular post 123 of the gate member 12 about the pivot axis (A) in the second direction (F2). As shown in FIG. 7, when the anchor seat 3 of the second restoring mechanism 14′ rotates in the second direction (F2) such that the first spring end 51 of the restoring spring 5 rotates therewith, because the stop 232 on the actuator 2 abuts against the end 434 of the control slot 433 in the control seat 4, the actuator 2 arrests rotation of the control seat 4 relative to the gate frame 11 about the pivot axis (A), and the first spring end 51 rotates relative to the second spring end 52 of the restoring spring 5, thereby enabling the restoring spring 5 of the second restoring mechanism 14′ to accumulate the restoring force for restoring the gate member 12 from the second open position back to the closed position. In the meantime, as shown in FIG. 6, when the anchor seat 3 of the first restoring mechanism 14 rotates in the second direction (F2) such that the first spring end 51 of the restoring spring 5 rotates therewith, due to the angular displacement between the stops 232 of the first and second restoring mechanisms 14, 14′, the actuator 2 of the first restoring mechanism 14 permits rotation of the control seat 4 of the first restoring mechanism 14 with the tubular post 123 of the gate member 12 in the second direction (F2) such that relative rotation between the first and second spring ends 51, 52 of the restoring spring 5 of the first restoring mechanism 14 can be avoided. In other words, the first restoring mechanism 14 does not accumulate a restoring force when the gate member 12 is swung from the closed position to the second open position.

It has thus been shown that the safety gate 1 of this invention includes the first restoring mechanism 14 that accumulates a restoring force only when the gate member 12 is swung from the closed position to the first open position, and the second restoring mechanism 14′ that accumulates a restoring force only when the gate member 12 is swung from the closed position to the second open position. As compared to the prior art that uses only one spring, the restoring mechanisms 14, 14′ in this invention are not easily damaged to ensure the bi-directional restoring functionality of the safety gate 1.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A safety gate comprising:
a gate frame;
a gate member; and
first and second restoring mechanisms for mounting pivotally said gate member on said gate frame such that said gate member can be swung relative to said gate frame about a pivot axis in a first direction from a closed position to a first open position, and in a second direction from the closed position to a second open position;
said first restoring mechanism operating to accumulate a restoring force for restoring said gate member from the first open position to the closed position when said gate member is swung in the first direction from the closed position to the first open position;
said second restoring mechanism operating to accumulate a restoring force for restoring said gate member from the second open position to the closed position when said gate member is swung in the second direction from the closed position to the second open position.

2. The safety gate as claimed in claim 1, wherein each of said first and second restoring mechanisms includes:
a restoring spring having a first spring end anchored to said gate member, and a second spring end;
a control seat coupled to said second spring end of said restoring spring; and
an actuator connected to said gate frame;
wherein, for said first restoring mechanism, said actuator is operably associated with said control seat to result in relative rotation between said first and second spring ends of said restoring spring about the pivot axis when said gate member is swung from the closed position to the first open position, thereby enabling said restoring spring to accumulate the restoring force for restoring said gate member from the first open position back to the closed position; and
wherein, for said second restoring mechanism, said actuator is operably associated with said control seat to result in relative rotation between said first and second spring ends of said restoring spring about the pivot axis when said gate member is swung from the closed position to the second open position, thereby enabling said restoring spring to accumulate the restoring force for restoring said gate member from the second open position back to the closed position.

3. The safety gate as claimed in claim 2, wherein:
for said first restoring mechanism, said actuator arrests rotation of said control seat relative to said gate frame about the pivot axis when said gate member is swung from the closed position to the first open position; and
for said second restoring mechanism, said actuator arrests rotation of said control seat relative to said gate frame about the pivot axis when said gate member is swung from the closed position to the second open position.

4. The safety gate as claimed in claim 3, wherein:
for said first restoring mechanism, said actuator permits rotation of said control seat with said gate member about the pivot axis when said gate member is swung from the closed position to the second open position; and
for said second restoring mechanism, said actuator permits rotation of said control seat with said gate member about the pivot axis when said gate member is swung from the closed position to the first open position.

5. The safety gate as claimed in claim 4, wherein, for each of said first and second restoring mechanisms, said control seat includes a tubular wall formed with a circumferentially extending control slot, and said actuator extends into said tubular wall of said control seat and is formed with a stop that is disposed radially relative to the pivot axis and that extends into said control slot, said stop having a circumferential width shorter than a circumferential length of said control slot, and abutting against one end of said control slot to arrest rotation of said control seat relative to said gate frame about the pivot axis.

6. The safety gate as claimed in claim 5, wherein said gate frame includes a pair of gate connecting sections, said actuator of each of said first and second restoring mechanisms further having an insert part that is inserted non-rotatably into a respective one of said gate connecting sections of said gate frame.

7. The safety gate as claimed in claim 2, wherein said gate member includes a tubular post, and said restoring and said control seat of each of said first and second restoring mechanisms are disposed in said tubular post of said gate member.

8. The safety gate as claimed in claim 7, wherein each of said first and second restoring mechanisms further includes an anchor seat fixed in said tubular post and having said first spring end of said restoring spring anchored thereto.

9. The safety gate as claimed in claim 1, further comprising a latch for latching releasably said gate member to said gate frame at the closed position.
